(19) United States
(12) Patent Application Publication
(10) Pub. No.: US 2016/0341555 A1
(43) Pub. Date: Nov. 24, 2016

(54) SYSTEM FOR AUTO-UPDATING ROUTE-DATA USED BY A PLURALITY OF AUTOMATED VEHICLES

(71) Applicant: DELPHI TECHNOLOGIES, INC., TROY, MI (US)

(72) Inventors: MICHAEL H. LAUR, MISSION VIEJO, CA (US); JOHN P. ABSMEIER, CAPITOLA, CA (US); TORY P. SMITH, MOUNTAIN VIEW, CA (US)

(21) Appl. No.: 14/717,281

(22) Filed: May 20, 2015

(51) Int. Cl. G01C 21/20; B60R 1/00; G05D 1/00

(52) U.S. Cl. CPC G01C 21/20; G05D 1/0088; B60R 1/00; B60R 2300/804

(57) ABSTRACT

A system for updating route-data shared by vehicles for automated operation of the vehicles includes a shared-memory, a sensor, and a communication-network. The shared-memory stores route-data used by a plurality of vehicles for automated operation of the vehicles in accordance with a control-rule included in the route-data. The sensor is installed in a first-vehicle of the vehicles. The sensor is used to determine an observed-parameter so the system can detect when the observed-parameter violates a parameter-limit during automated operation of the first-vehicle in accordance with the control-rule. The communication-network is configured to enable the first-vehicle to update the route-data when the observed-parameter violates the parameter-limit. Then other vehicles can access the shared-memory so the other vehicles can negotiate a roadway using the most up-to-date information about the roadway.

### TECHNICAL FIELD OF INVENTION

This disclosure relates to a system that automatically updates route-data shared by vehicles for automated operation of the vehicles, and more particularly relates to updating the route-data when, during automated operation of the vehicle, an observed-parameter observed by a vehicle violates a parameter-limit of vehicle operation while the vehicle is being operated in accordance with a control-rule included in the route-data.

### BACKGROUND OF INVENTION

Autonomous or automated operation of vehicles is known. The degree of automation includes full automation where the operator of a host-vehicle does not directly control any aspect of vehicle operation. That is, the operator is essentially a passenger, and a controller in the host-vehicle takes control of all steering, braking, and engine control (e.g. acceleration) operations of the host-vehicle. In some traffic scenarios an automated vehicle may be able to provide a comfortable transportation experience for a passenger of the automated vehicle using only on-board sensors to determine, for example, what speed should be used to negotiate or travel a curve in a roadway. However, in some instances, automated operation of the vehicle could be improved if the vehicle had access to route-data that included a suggestion as to what speed is appropriate for a particular curve.

### SUMMARY OF THE INVENTION

In accordance with one embodiment, a system for updating route-data shared by vehicles for automated operation of the vehicles is provided. The system includes a shared-memory, a sensor, and a communication-network. The shared-memory stores route-data used by a plurality of vehicles for automated operation of the vehicles in accordance with a control-rule included in the route-data. The sensor is installed in a first-vehicle of the vehicles. The sensor is used to determine an observed-parameter so the system can detect when the observed-parameter violates a parameter-limit during automated operation of the first-vehicle in accordance with the control-rule. The communication-network is configured to enable the first-vehicle to update the route-data when the observed-parameter violates the parameter-limit.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a diagram of a system for updating route-data shared by a plurality of vehicles in accordance with one embodiment;

FIG. 2 is a diagram of the system of FIG. 1 in accordance with one embodiment;

FIG. 3 is a traffic scenario that the system of FIG. 1 may experience in accordance with one embodiment; and

FIG. 4 is a traffic scenario that the system of FIG. 1 may experience in accordance with one embodiment.

### DETAILED DESCRIPTION

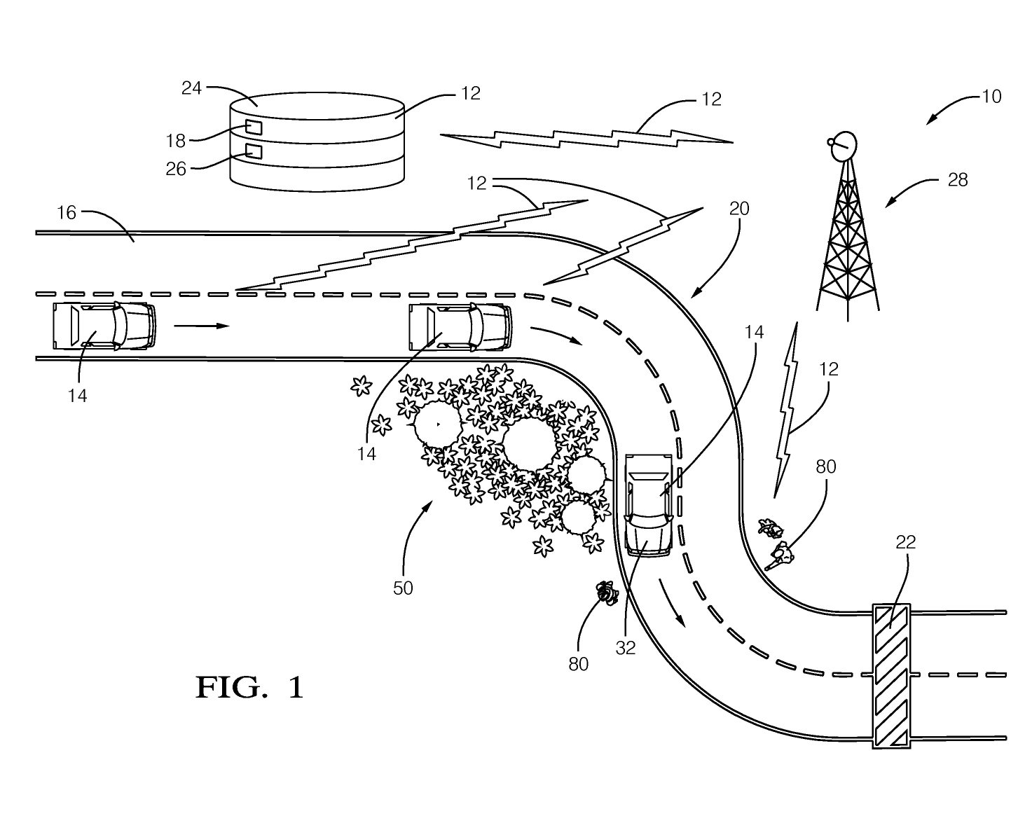

FIG. 1 illustrates a non-limiting example of a system 10 for updating route-data 12 shared by a plurality of vehicles, hereafter referred to as the vehicles 14. The route-data 12 may be used by any of the vehicles 14 for automated operation of the vehicles 14. As used herein, the route-data 12 may include, but is not limited to, map-information that the vehicles 14 use to plan a route to a destination; a recommended-speed 18 for a particular section of a roadway 16 such as a roadway-curve 20 in the roadway 16; and the location of a pedestrian-crossing 22 where there may be a need to suddenly apply brakes.

In order to keep the vehicles 14 programmed with the most recent content of the route-data 12, the system includes a shared-memory 24 that stores the route-data 12 used by the vehicles 14 for automated operation of the vehicles 14 in accordance with a control-rule 26 included in the route-data 12. In general, the shared-memory 24 provides a means for the vehicles 14 to access a shared source of information. While the shared-memory is illustrated as something comparable to a disk-drive, it is contemplated that the information stored by the shared-memory 24 may be a distributed on-line accessible memory which is sometimes referred to as ‘in-the-cloud’ storage.

The route-data 12 may be communicated to the vehicles 14 by a communication-network 28. The communication-network 28 may be a ground-based network such as a cellular telephone network as suggested by the illustration. Alternatively, the communication-network 28 may include one or more satellites so the route-data 12 can be sent to the vehicles 14 in real-time at even the most remote locations. As another alternative, the route-data 12 may be communicated to the vehicles 14 via localized computer hot-spots during an over-night update of any electronic copies of the route-data 12 stored in the vehicles 14.

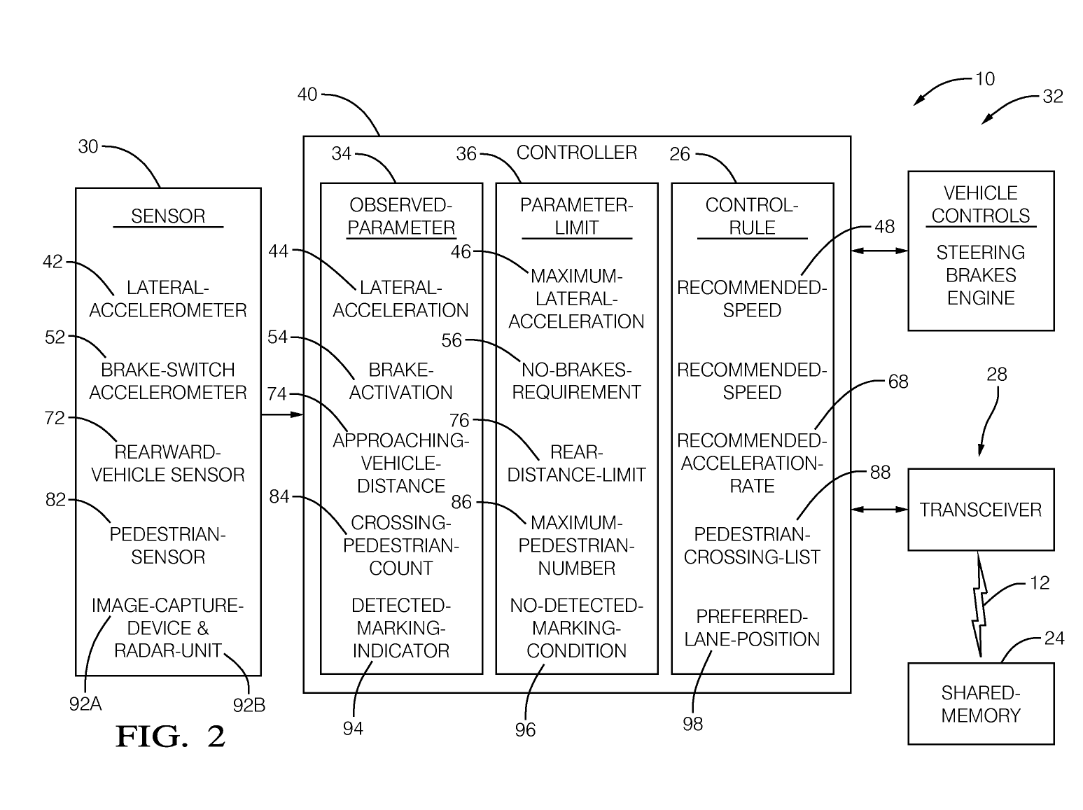

FIG. 2 further illustrates non-limiting details of the system 10 described herein. In order to monitor the quality, accuracy, or appropriateness of of the route-data 12, the system 10 may include a sensor 30 installed in a first-vehicle 32 of the vehicles 14. The modifier ‘first’ is used only to distinguish the first-vehicle 32 from the rest of the vehicles 14, and is not intended to, for example, suggest that the first-vehicle 32 is necessarily first to negotiate the roadway-curve 20. The sensor 30 may include any combination of the various specific sensors suggested, but the sensor 30 is not limited to only those specific sensors. In general, the sensor 30 is used to determine an observed-parameter 34 so the system 10 can detect when the observed-parameter 34 violates (e.g. exceeds) a parameter-limit 36 during automated operation of the first-vehicle 32 in accordance with the control-rule 26.

As used herein, the observed-parameter 34 is typically some operational state or measurable characteristic experienced by the first-vehicle 32 that can be observed or measured by the sensor 30. Also as used herein, the parameter-limit 36 is typically a threshold or condition to which the observed-parameter 34 can be compared to determine when the observed-parameter 34 has violated or exceeded the parameter-limit 36.

In order to perform such comparisons, the first-vehicle 32 may include a controller 40 configured to perform the comparison of the parameter-limit 36 to the observed-parameter 34, as well as operate the first-vehicle 32 in accordance with the route-data 12, and in particular in accordance with the control-rule 26. The controller 40 may include a processor (not shown) such as a microprocessor or other control circuitry such as analog and/or digital control circuitry including an application specific integrated circuit (ASIC) for processing data as should be evident to those in the art. The controller 40 may include memory to store the parameter-limit 36, including non-volatile memory, such as electrically erasable programmable read-only memory (EEPROM) for storing one or more routines, thresholds and captured data. The one or more routines may be executed by the processor to perform steps for determining if the observed-parameter 34 received by the controller 40 violates or exceeds the parameter-limit 36, as described herein.

A notable advantage of the system 10 is that the communication-network 28 is generally configured to enable the first-vehicle 32 to update the route-data 12 stored in the shared-memory 24 when the observed-parameter 34 violates the parameter-limit 36. It should be understood that the general intent of the control-rule 26, which may be part of the route-data 12 from the shared-memory 24, is to provide guidelines or rules for the controller 40 to use to operate the first-vehicle 32. It is the intent that the parameter-limit 36 will not be violated if the first-vehicle 32 is operated in accordance with the control-rule 26. However, if there is some unrecognized characteristic of the roadway 16 or an unexpected change to the roadway 16, the parameter-limit 36 may be violated even though the first-vehicle 32 was operated in accordance with the control-rule 26. In order to perform a continuous verification of the control-rule 26, the system 10 is configured so the first-vehicle 32 is able to communicate with the shared-memory 24 so instances when the parameter-limit 36 is violated may be tabulated and the control-rule 26 can be revised. The control-rule revision may be to the control-rule 26 stored in the controller 40, and/or the control-rule 26 stored in the shared-memory 24.

The following is a description of several non-limiting examples of traffic scenarios where the parameter-limit 36 is violated even though the first-vehicle 32 was operated in accordance with the control-rule 26. In each example, when the observed-parameter 34 violates the parameter-limit 36, the control rule 26 stored in the controller 40, and/or the control-rule 26 stored in the shared-memory 24 is updated accordingly so the observed-parameter 34 is not violated.

Continuing to refer to FIGS. 1 and 2, the sensor 30 in the first-vehicle 32 may include a lateral-accelerometer 42. Accordingly, the observed-parameter 34 includes a lateral-acceleration 44. The parameter-limit 36 includes a maximum-lateral-acceleration 46, which may be determined based on engineering-judgment of what customers will deem comfortable, customer feedback, and/or prior experience in similar situations. In the particular scenario illustrated in FIG. 1, the control-rule 26 may include or indicate a recommended-speed 48 for a roadway-curve 20. In this example, there is an obstruction 50 (e.g. vegetation) that prevents the automated operating system of the vehicles 14 from viewing all of the roadway-curve 20 which may have a decreasing radius.

The first-vehicle 32 is shown as having already traveled through or negotiated the roadway-curve 20. If the first-vehicle 32 entered the roadway-curve 20 at the recommended-speed 48, but the unexpected decreasing radius of the roadway-curve 20 caused the lateral-acceleration 44 to violate (i.e. exceed) the maximum-lateral-acceleration 46. In response, the first-vehicle 32 may communicate with the shared-memory 24 to decreases the recommended-speed 48 for the roadway-curve 20 so the vehicles 14 that are approaching/entering the roadway-curve 20 at a lower speed than did the first-vehicle 32. By updating the route-data 12 stored in the shared-memory, the system 10 prevents the vehicles 14 that are approaching the roadway-curve 20 from experiencing excessive lateral acceleration.

Continuing to refer to FIGS. 1 and 2, the sensor 30 may include a brake-switch 52, and the observed-parameter 34 includes a brake-activation 54. If the recommended speed 48 for the roadway-curve 20 is such that an operator/passenger (not shown) in the first-vehicle 32 is uncomfortable with the experienced lateral acceleration and the brakes are applied by the operator/passenger, that may be an indication that the recommended-speed 48 should be lowered. That is, the parameter-limit 36 may have or include a no-brakes-requirement 56, but the operation of the brakes by the operator/passenger violates the no-brakes-requirement 56. As before, the control-rule indicates a recommended-speed 48 for a roadway-curve 20, and the first-vehicle 32 communicates with the shared-memory 24 to decreases the recommended-speed 48 for the roadway-curve 20 if the brake-activation 54 indicates that the brakes were applied while the first-vehicle 32 travels the roadway-curve 20 at the recommended-speed 48. An alternative cause for the application of brakes may be the presence of a disabled vehicle or construction, the view of which is blocked by the obstruction 50.

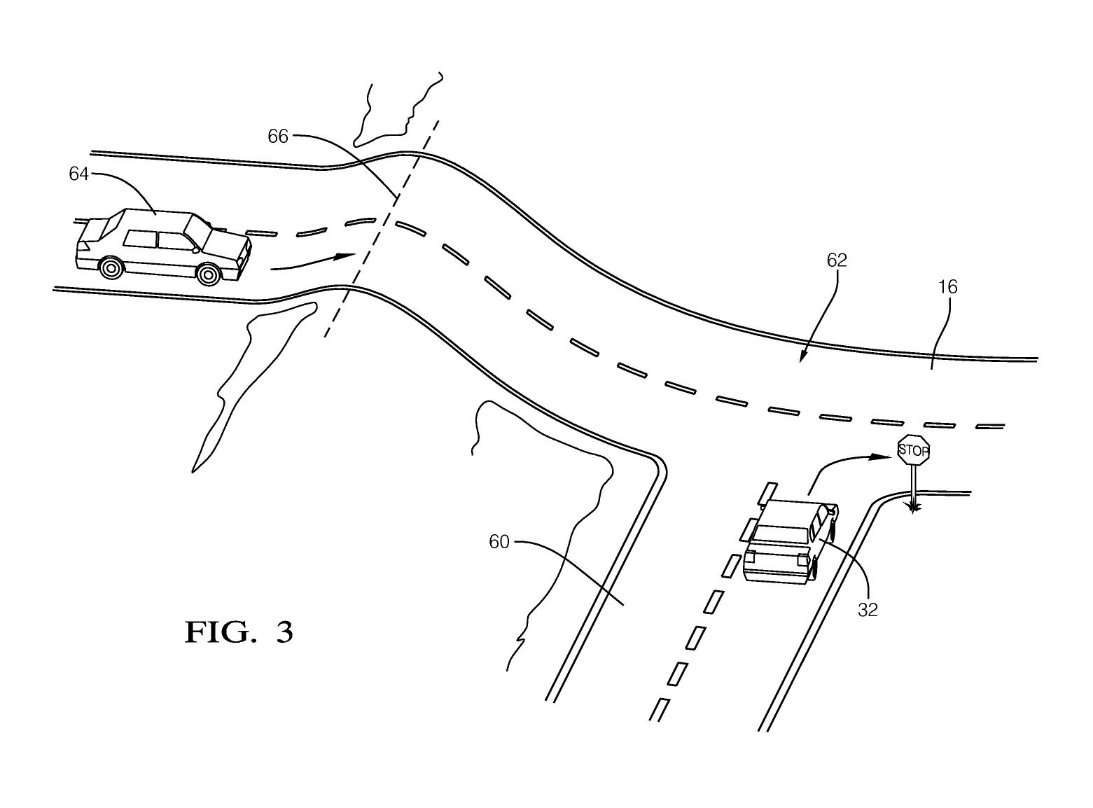

FIG. 3 illustrates another non-limiting example of a traffic scenario that the system 10 may experience where the first-vehicle 32 is about to enter the roadway 16 from a side-road 60 via an intersection 62. The scenario includes an approaching-vehicle 64 that cannot be seen from the intersection 62 because of a hill. That is, the approaching-vehicle 64 will not be detectable by the first-vehicle 32 from the intersection 62 until after the approaching-vehicle 64 clears or passes the crest 66 of the hill. The control-rule 26 may include or indicate a recommended-acceleration-rate 68 for accelerating from the intersection 62 after a turn in or through the intersection 62. The recommended-acceleration-rate 68 may be determined based on fuel-economy and/or operator/passenger comfort considerations. If the first-vehicle 32 enters the intersection 62 to complete the turn as illustrated, and the approaching-vehicle 64 passes the crest 66, the approaching-vehicle 64 may need to decelerate rapidly in order to avoid a collision with the first-vehicle 32.

In order to help avoid future near-collision and hard braking by other vehicles in the same situation as the first-vehicle 32 and the approaching-vehicle 64, the sensor 30 may include a rearward-vehicle-sensor 72 (FIG. 2) such as a camera, radar unit, or LIDAR unit able to detect that the approaching-vehicle 64 is rapidly approaching the first-vehicle 32. The observed-parameter 34 may include an approaching-vehicle-distance 74 indicated by the rearward-vehicle-sensor 72, and the parameter-limit 36 includes a rear-distance-limit 76. If the approaching-vehicle 64 gets too close to the first-vehicle 32, it may be preferable that the first-vehicle 32 sacrifice some fuel efficiency and accelerate from the intersection 62 at an increased rate greater than the recommended-acceleration-rate 68. Accordingly, the first-vehicle 32 may communicate with the shared-memory 24 to increase the recommended-acceleration-rate 68 for the intersection 62 if the rearward-vehicle-sensor 72 detects the approaching-vehicle 64 and the approaching-vehicle-distance 74 is less than the rear-distance-limit 76 while the first-vehicle 32 accelerates from the intersection 62 at the recommended-acceleration-rate 68.

Continuing to refer to FIG. 3, if there was another vehicle (not shown) forward of or in front of the first-vehicle 32 after the first-vehicle 32 completes the turn onto the roadway 16, and the control-rule 26 included a minimum-following-distance (not shown) between the first-vehicle 32 and the other vehicle, the controller 40 may be configured to violate the minimum-following-distance in order to minimize a pending impact with the approaching-vehicle 64.

Referring again to FIGS. 1 and 2, the sensor 30 may include a pedestrian-sensor 82 (e.g. a camera) configured to detect pedestrians 80 proximate to and/or crossing the roadway 16 at the location where the first-vehicle 32 is shown in FIG. 1. The observed-parameter 34 includes a crossing-pedestrian-count 84, and the parameter-limit 36 includes a maximum-pedestrian-number 86. The control-rule 26 includes or indicates a pedestrian-crossing-list 88 for the roadway 16. That is, the expected location of the pedestrian-crossing 22 is provided to the first-vehicle 32 by the shared-memory 24. However, if a sufficient number of the pedestrians 80 are detected at locations other than at the expected location of the pedestrian-crossing 22, it may be advantageous to provide notice to those of the vehicle 14 that are approaching this unexpected pedestrian crossing. Accordingly, the first-vehicle 32 may communicate with the shared-memory 24 to revise the pedestrian-crossing-list 88 for the roadway 16 when the crossing-pedestrian-count 84 indicated by the pedestrian-sensor 82 is greater than the maximum-pedestrian-number 86 (e.g. three) at a location not present on the pedestrian-crossing-list 88 for the roadway 16.

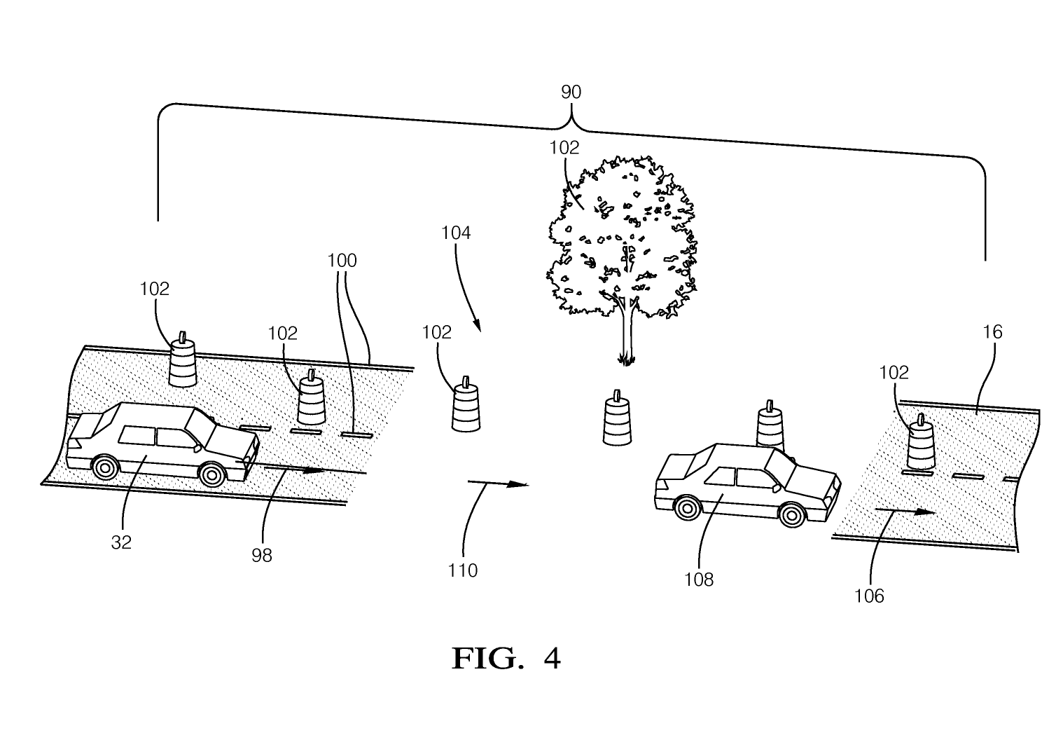

FIG. 4 illustrates another non-limiting example of a traffic scenario that the system 10 may experience where the first-vehicle 32 is about to enter a construction-zone 90. The sensor 30 may include an image-capture-device 92A (FIG. 1) configured to detect a lane-marking 100 and an other-feature 102 (e.g. construction zone barrel or a tree) of a roadway-location 104 traveled by the first-vehicle 32, and a radar-unit 92B configured to determine a roadway-position 106 of a second-vehicle 108 proximate to the roadway-location 104 and forward of the first-vehicle 32. When the lane-marking is readily apparent during automated operation of the first-vehicle 32, the observed-parameter 34 includes a detected-marking-indicator 94, and the control-rule 26 indicates that a preferred-lane-position 98 is determined based on the relative locations of the lane-marking 100 when the detected-marking-indicator 94 is indicated, i.e. the lane-marking 100 is detected or TRUE.

In the construction-zone 90 the lane-marking may be temporarily removed, and even the roadway may be missing such that only an ill-defined dirt or gravel surface is available to drive upon. In this situation the detected-marking-indicator 94 is not indicated, i.e. the lane-marking 100 is undetected or FALSE, or the no-detected-marking-condition 96 is indicated. As such, the parameter-limit 36 which includes a no-detected-marking-condition 96 is violated. If the second-vehicle 108 is present where illustrated, then the preferred-lane-position may be determined based on the roadway-position 106 of the second-vehicle 108. The system 10 may be configured so the first-vehicle 32 communicates with the shared-memory 24 to update the route-data 12 for the roadway-location 104 to include a relative-position 110 of the other-feature 102 with respect to the roadway-position 106 of the second-vehicle 108 so the control-rule 26 indicates that the preferred-lane-position 98 at the roadway-location 104 is determined based on the relative-position 110 of other-feature 102 when the no-detected-marking-condition 96 is indicated. That is, the first-vehicle 32 determines or learns where to travel through the construction-zone 90 based on where the other-feature 102 was located relative to the second-vehicle 108. Then, when the first-vehicle 32 or any of the vehicles 14 must subsequently travel through the construction-zone 90 when the second-vehicle 108 is not present, the preferred-lane-position 98 can be determine based on the relative-position 110 which is measured or determined relative location of the other-feature 102.

Accordingly, a system 10 for updating the route-data 12 shared by a plurality of the vehicles 14 for automated operation of the vehicles is provided. The shared memory 24 may advantageously be updated by any of the vehicles 14 so that all of the vehicles 14, including the first-vehicle 32, can access the most recent data about the roadway 16 on which the vehicles 14 travel.

While this invention has been described in terms of the preferred embodiments thereof, it is not intended to be so limited, but rather only to the extent set forth in the claims that follow.

We claim:

1. A system for updating route-data shared by vehicles for automated operation of the vehicles, said system comprising:
a shared-memory that stores route-data used by a plurality of vehicles for automated operation of the vehicles in accordance with a control-rule included in the route-data;
a sensor installed in a first-vehicle of the vehicles, said sensor used to determine an observed-parameter so the system can detect when the observed-parameter violates a parameter-limit during automated operation of the first-vehicle in accordance with the control-rule; and
a communication-network configured to enable the first-vehicle to update the route-data when the observed-parameter violates the parameter-limit.

2. The system in accordance with claim 1, wherein
the sensor includes a lateral-accelerometer,
the observed-parameter includes a lateral-acceleration,
the parameter-limit includes a maximum-lateral-acceleration,
the control-rule indicates a recommended-speed for a roadway-curve, and
the first-vehicle communicates with the shared-memory to decreases the recommend-speed for the roadway-curve if the lateral-acceleration exceeds the maximum-lateral-acceleration while the first-vehicle travels the roadway-curve at the recommended-speed.

3. The system in accordance with claim 1, wherein
the sensor includes a brake-switch,
the observed-parameter includes a brake-activation,
the parameter-limit includes a no-brakes-requirement,
the control-rule indicates a recommended-speed for a roadway-curve, and
the first-vehicle communicates with the shared-memory to decreases the recommend-speed for the roadway-curve if the brake-activation indicates that the brakes were applied while the first-vehicle travels the roadway-curve at the recommended-speed.

4. The system in accordance with claim 1, wherein
the sensor includes a rearward-vehicle-sensor,
the observed-parameter includes an approaching-vehicle-distance,
the parameter-limit includes a rear-distance-limit,
the control-rule indicates a recommended-acceleration-rate for accelerating from an intersection after a turn in the intersection, and
the first-vehicle communicates with the shared-memory to increase the recommend-acceleration-rate for the intersection if the rearward-vehicle-sensor detects an approaching-vehicle and the approaching-vehicle-distance is less than the rear-distance-limit while the first-vehicle accelerates from the intersection at the recommended-acceleration-rate.

5. The system in accordance with claim 1, wherein
the sensor includes a pedestrian-sensor,
the observed-parameter includes a crossing-pedestrian-count,
the parameter-limit includes a maximum-pedestrian-number,
the control-rule indicates a pedestrian-crossing-list for a roadway, and
the first-vehicle communicates with the shared-memory to revise the pedestrian-crossing-list for the roadway when the crossing-pedestrian-count indicated by the pedestrian-sensor is greater than the maximum-pedestrian-number at a location not present on the pedestrian-crossing-list for the roadway.

6. The system in accordance with claim 1, wherein
the sensor includes an image-capture-device configured to detect a lane-marking and an other-feature of a roadway-location traveled by the first-vehicle, and a radar-unit configured to determine a roadway-position of a second-vehicle proximate to the roadway-location and forward of the first-vehicle,
the observed-parameter includes a detected-marking-indicator,
the parameter-limit includes a no-detected-marking-condition,
the control-rule indicates that a preferred-lane-position is determined based on the lane-marking when the detected-marking-indicator is indicated, and the preferred-lane-position is determined based on the roadway-position of the second-vehicle when the no-detected-marking-condition is indicated, and
the first-vehicle communicates with the shared-memory to update the route-data for the roadway-location to include a relative-position of the other-features with respect to the roadway-position of the second-vehicle so the control-rule indicates that the preferred-lane-position at the roadway-location is determined based on the other-feature when no-detected-marking-condition is indicated.
